(19) United States
(12) Patent Application Publication
(10) Pub. No.: US 2007/0116394 A1
(43) Pub. Date: May 24, 2007

(54) SLEWING RING HAVING IMPROVED INNER RACE CONSTRUCTION

(75) Inventor: Terry Hart, Kent, OH (US)

Correspondence Address: GIFFORD, KRASS, SPRINKLE,ANDERSON & CITKOWSKI, P.C, PO BOX 7021, TROY, MI, 48007-7021, US

(73) Assignee: Thyssenkrupp - Rotek, Inc., Aurora, OH (US)

(21) Appl. No.: 11/561,920

(22) Filed: Nov. 21, 2006

Related U.S. Application Data
(60) Provisional application No. 60/738,959, filed on Nov. 22, 2005.

(51) Int. Cl. F16C 33/58

(52) U.S. Cl. 384/513

(57) ABSTRACT

A slewing ring affording enhancement of dimensional stability with respect to the ring itself and any components attached thereto is provided. The ring includes an annular outer race and an annular inner race which is rotatably coupled to the outer race. The outer race and the inner race are arranged concentrically about a axis. At least one bearing is located between the outer race and the inner race. In addition, the inner race includes an annular upper member and an annular lower member, the upper member having a retaining segment that extends coaxially to the axis and the lower member having a U-shaped recess that is adapted to accept the retaining segment. The incorporation of the retaining segment in combination with the U-shaped recess affords for enhanced dimensional stability and accommodation of shearing or off-axis loading subjected to the slewing ring.

### CROSS-REFERENCE TO RELATED APPLICATIONS

This application claims priority of U.S. Provisional Patent Application Ser. No. 60/738,959 filed Nov. 22, 2005, which is incorporated herein by reference.

### FIELD OF THE INVENTION

This invention relates generally to ring bearings and specifically relates to a slewing ring with enhanced dimensional stability.

### BACKGROUND OF THE INVENTION

Bearings are widely used to minimize friction between rotatably coupled components that exhibit movement relative to one another. Components used in the fields of medicine, automotive manufacturing, power generation, and the like, can require two components to rotate relative to one another and maintain tight tolerances with respect to their location about a axis. A slewing ring affords for one component to rotate about a axis relative to a second component. However, some applications expose the components and the slewing ring to shearing or off-axis loading which can subsequently cause excess movement in undesirable off-axis directions and/or increase the friction between said components. Therefore, it is desirable to improve the performance of slewing rings, particularly when said rings are under high stress or loading conditions. The stewing ring of the present invention affords for enhanced dimensional stability of the ring and components attached thereto. These and other advantages of the invention will be apparent from the drawings and discussion presented herein.

### SUMMARY OF THE INVENTION

A slewing ring affording enhanced dimensional stability is provided. The ring includes an annular outer race and an annular inner race rotatably coupled to the outer race. The outer race and the inner race are arranged concentrically about an axis. At least one ball bearing is located between the outer race and the inner race. In addition, the inner race includes an annular upper member and an annular lower member. The upper member of the inner race has a retaining segment that extends coaxially with the axis. The lower member of the inner race has a U-shaped recess that is adapted to accept the retaining segment. The retaining segment in combination with the U-shaped recess affords for a slewing ring with increased capability to handle applied shearing or off-axis loading, and thereby provides enhanced dimensional stability.

### BRIEF DESCRIPTION OF THE DRAWINGS

FIG. 1 illustrates a top view of an inventive slewing ring;

FIG. 2 illustrates a first cross-sectional side view of the inventive slewing ring;

FIG. 3 illustrates a second cross-sectional side view of the inventive slewing ring; and

FIG. 4 illustrates a third cross-sectional side view of the inventive slewing ring.

### DETAILED DESCRIPTION OF THE INVENTION

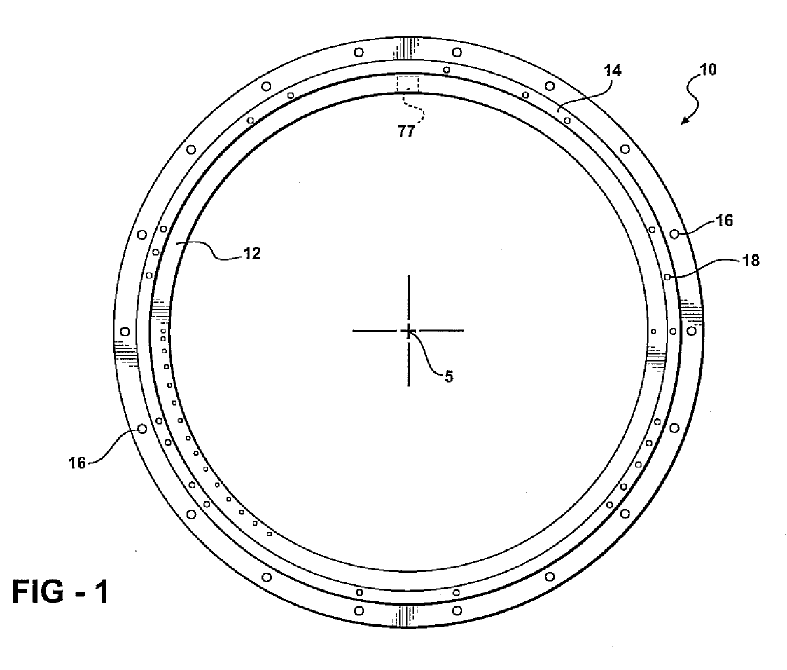

Referring to FIG. 1, a top view of a ring bearing 10, also known as a slewing ring by those skilled in the art, is shown. The slewing ring 10 has an annular inner race 12 and an annular outer race 14. The inner 12 and outer 14 races are arranged concentrically about an axis 5. Preferably the axis 5 is fixed, but this is not required for the present invention to be operative. The inner 12 and outer 14 races are rotatably coupled to each other for relative rotation about the axis 5. The inner race 12 can have a plurality of apertures or bores 16 allowing attachment of the inner race 12 to a first component (not shown) and the outer race 14 can have a plurality of apertures or bores 18 allowing attachment of the outer race 14 to a second component (not shown). By this arrangement, the ring 10 rotatably couples a first component to a second component and affords relative rotation between said components about a common axis.

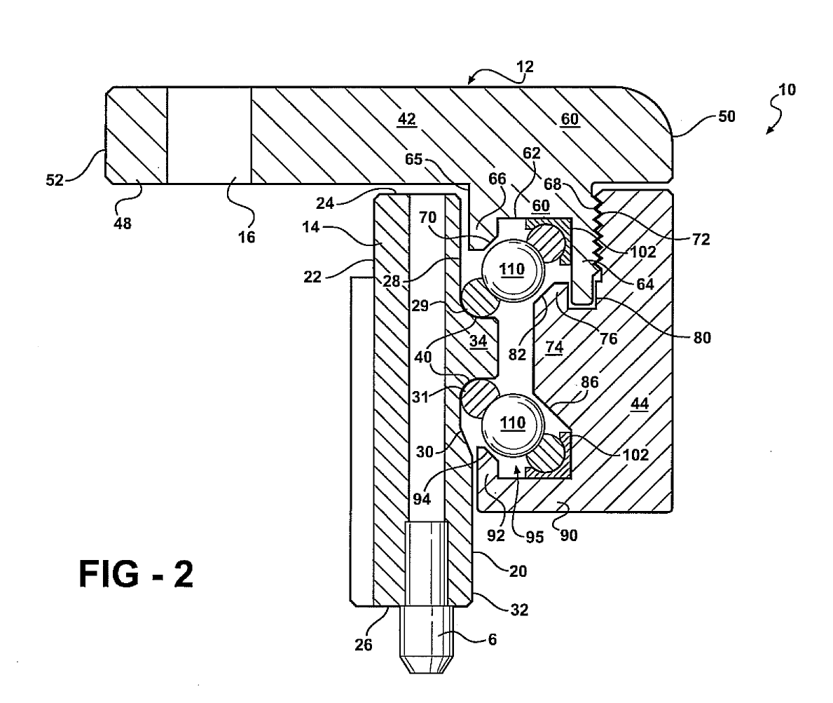

Turning to FIGS. 2-4, various cross-sectional side views of the slewing ring 10 are shown, revealing the present invention in more detail. The outer race 14 has a generally rectangular cross section defined by opposite inner 20 and outer 22 walls which extend in an axial direction, and opposite top 24 and bottom 26 ends which extend in a radial direction.

The inner wall 20 is defined by first 28, second 30 and third 32 surfaces, and a step 34. The third surface 32 is disposed adjacent the bottom end 26 of the cross section. The third surface 32 has a diameter that is smaller than the first 28 and second 30 surfaces wherein said diameter is measured from the axis 5. In the alternative, the third surface 32 has a diameter that is larger than the first 28 and second 30 surfaces. The first surface 28 is disposed adjacent the top end 24. The first 28 and second 30 surfaces have generally the same diameter. In the alternative, the first 28 and second 30 surfaces do not have the same diameter.

The step 34 is positioned between the first 28 and second 30 surfaces and protrudes radially inwardly towards axis 5 relative to said surfaces 28 and 30. The step 34 has a diameter that is smaller than that of the third 32 surface, or in the alternative step 34 has a diameter that is large than that of the third surface 32.

Radii 40 are defined between the step 34 and the first 28 and second 30 surfaces, and thereby afford a first bearing ring seat surface 29 having the radius 40 and a second bearing ring seat surface 31 having the radius 40.

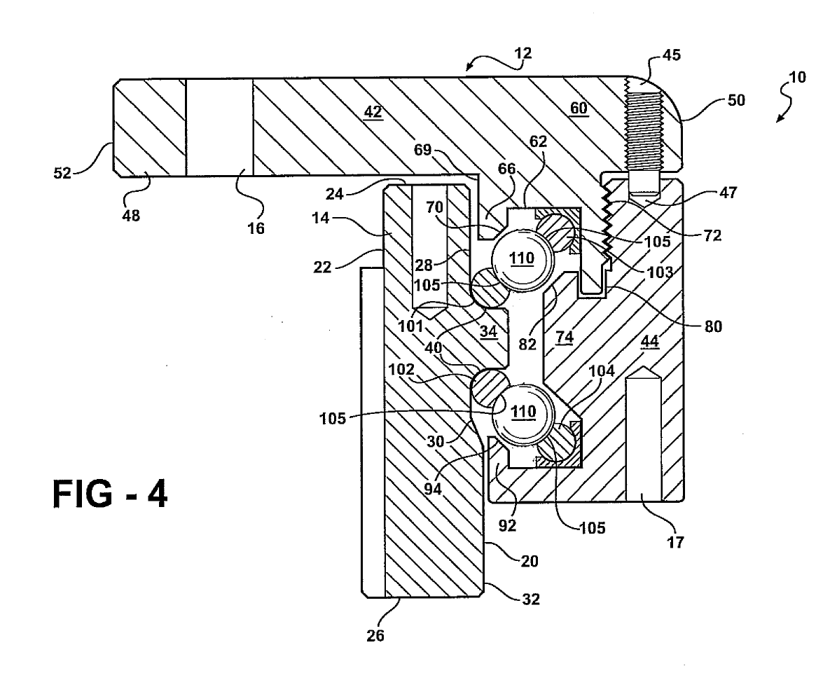

The inner race 12 has annular upper 42 and lower 44 members. The upper member 42 is fixedly secured to the lower member 44 using any attachment means known to those skilled in the art, illustratively including a plurality of bolts, rods or pins (not shown) with corresponding apertures. In one embodiment bolts extend through corresponding bores 45 and 57 formed in the upper 42 and lower 44 members, respectively, as shown in FIG. 4.

Although not required for the present invention to be operative, one embodiment includes the upper member 42 of the lower race 12 with a generally rectangular cross section, the length of which is arranged orthogonally with respect to the length of the outer race 14. The upper member 42 has opposite upper 46 and lower 48 walls, and opposite inner 50 and outer 52 ends. The outer end 52 has a diameter that is larger than the diameter of the outer wall 22 of the inner race 12.

The plurality of apertures or bores 16 of the inner race 12 can be formed in the upper member 42 and arranged along a region defined between the outer end 52 of the upper member 42 and the outer wall 22 of the outer race 14. Bolts, pins or rods can be placed at least partially within the bores 16 in order to afford attachment of a component to the upper member 42.

A flange 60 extends in an axial direction from the lower wall 48 of the upper member 42, as shown in FIG. 2. The flange 60 includes a middle surface 62 that is parallel and spaced apart from the lower wall 48. In the alternative, the middle surface 62 is not parallel to the lower wall 48.

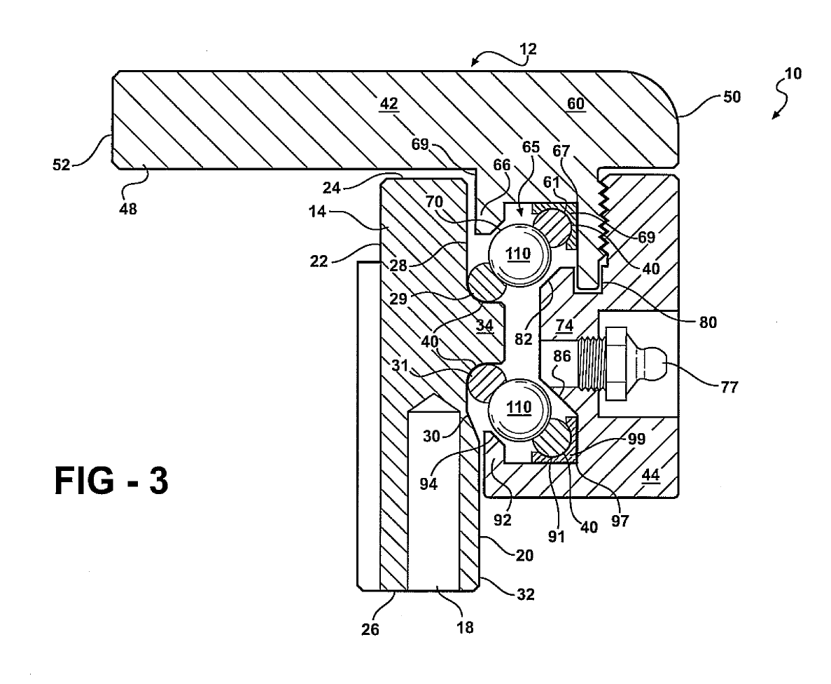

A first 64 and second 66 retaining segments extend coaxially, with respect to the axis 5, from the middle surface 62. The first 64 and second 66 retaining segments are generally parallel with each other, such that a generally U-shaped upper pocket 65 is formed therebetween, as shown in FIGS. 2 and 3. For the purposes of the present invention, the term generally parallel is defined as two lines or surfaces being parallel to each other or deviate from being parallel to each other not more than 15 degrees. The first retaining segment 64 can be longer than the second retaining segment 66 and has an inside surface 68 with at least part of said surface 68 including helical threads extending radially inwardly.

The distal end of the second retaining segment 66 has an angled surface 70 facing radially inwardly toward the first retaining segment 64 at a 45 degree, or otherwise acute, angle with respect to the middle surface 62 of the flange 60. The second retaining segment 66 has an outside surface 65 opposite and generally parallel to the inside surface 68 of the first retaining segment 64. The outside surface 65 has a smaller diameter than that of the first surface 28 of the outer race 14 and is adjacent thereto.

The lower member 44 of the inner race 12 can optionally have a generally L-shaped cross-section. The lower member 44 includes an outside surface 72 having helical threads for threadingly engaging the threads on the inside surface 68 of the upper member 42. A step 74 extends radially outwardly relative to the outside surface 72 of the lower member 44. The step 74 is positioned below the outside surface 72 of the lower member 44.

A third retaining segment 76 extends axially from the step 74 and toward the flange 60 of the upper member 42. The distal end of the third retaining segment 76 has an angled surface 82 spaced apart and opposing the radial surface 70 of the second retaining segment 66. The third retaining segment 76 is generally parallel to and spaced outwardly relative to the outside surface 72 of the lower member 44.

The third retaining segment 76 and the outside surface 72 define a U-shaped recess 80 therebetween, said recess 80 adapted to accept the first retaining segment 64 of the upper member 42, as shown in FIG. 2. The U-shaped recess has a first side parallel to the outside surface 72 and a second side spaced apart and oppositely disposed from the first side. Adjoining the first side and the second side of the recess 80 is a bottom surface. The first retaining segment 64 likewise has a first side, said first side parallel to the inside surface 68, and a second side spaced apart and oppositely disposed from the first side. Adjoining the first side and the second side of the first retaining segment 64 is a bottom surface. The inventive slewing ring 10 affords for the first retaining segment 64 of the upper member 42 to extend into the U-shaped recess 80 defined between the third retaining segment 76 and the outside surface 72 of the lower member 44. The acceptance of the first retaining segment 64 into the recess 80 enhances the dimensional stability of the inner race 12 and reduces the effects of shearing or off-axis loading on the slewing ring 10 and any components attached thereto.

Preferably the depth of the U-shaped recess 80 and the portion of the third retaining segment 76 accepted therein is between 0.05 and 35% of the overall axial height of the inner race 12. More preferably the depth of the recess 80 is between 1 and 25% of the overall axial height of the inner race 12, and even more preferably is between 1 and 15%. Even yet more preferably, the depth of the U-shaped recess is between 2 and 10% of the overall axial height of the inner race 12.

The step 74 of the lower member 44 includes an angled surface 86 opposite the angled surface 82 on the third retaining segment 76. The angled surface 86 is oriented at a 45 degree, or otherwise acute, angle relative to the axis 5 of the ring bearing 10.

A leg 90 extends radially outward relative to, and is positioned below, the step 74. A fourth retaining segment 92 extends axially from the leg 90 in a direction towards the flange 60. The distal end of the fourth retaining segment 92 has an angled surface 94 spaced apart and generally parallel with the angled surface 86 of the step 74. The fourth retaining segment 92 is generally parallel to and spaced apart from the step 74 and defines a lower pocket 95 therebetween. The lower pocket 95 is generally symmetrically opposite to the upper pocket 65 of the upper member 42.

The upper pocket 65 and lower pocket 95 each include a corner 67 and 97, respectively, as shown in FIG. 3. Adjacent to and in contact with corners 67 and 97, corner inserts 69 and 99 can be included. Corner inserts 69 and 99 each have a radius 40 which faces, but is oppositely disposed from, the radius 40 between the step 34 and the first 28 and second 30 surfaces of outer race 14. The radii 40 of corner inserts 69 and 99 afford a third bearing ring seat surface 61 and a fourth bearing ring seat surface 91, respectively.

A first bearing ring 101 and a second bearing ring 102, each having a radius 40, are seated on opposite sides of the step 34 of the outer race 14. A third bearing ring 103 and a fourth bearing ring 104, also having a radius 40, are seated adjacent to corners 67 and 97. Specifically, the rings 101, 102, 103 and 104 are seated against first seat surface 29, second seat surface 31, third seat surface 61 and fourth seat surface 91, respectively.

Each of the rings 101 through 104 include bearing surfaces 105, said surfaces 105 being arcuate and having the same curvature as a ball bearing to be placed in contact therewith. In the alternative, the bearing surfaces 105 are non-acruate surfaces adapted to accept a bearing that is located adjacent to and in contact therewith. In the present embodiment, spaces are defined between the bearing surfaces 105 of rings 101 and 103, and the bearing surfaces 105 of rings 102 and 104, said spaces affording support for a plurality of bearings 110 located therebetween. For the purposes of the present invention, the term bearing, when used as a noun, is defined as an element that rolls between two races of a slewing ring, for example a ball.

The bearings 110 roll adjacent to and in between the bearing surface 105 of rings 101 and 103, and the bearing surfaces 105 of rings 102 and 104, and reduce friction between components rotating about the axis 5 and coupled to the slewing ring 10. For illustrative purposes only, the bearings 110 shown in the figures are in the form of ball bearings, however any type of bearing can be used in the present invention including roller bearings, needle roller bearings, tapered roller bearings and spherical roller bearings. For the purposes of the present invention, ball bearings are bearings in the form of spheres, roller bearings are bearings in the form of cylinders with a slightly greater length than diameter, needle roller bearings are bearings in the form of long and thin cylinders, tapered roller bearings are bearings in the form conical rollers, and spherical roller bearings are bearings in the form of rollers that are thicker in the middle and thinner at the ends.

The inner race 12 and the outer race 14 can each include additional apertures, bores and/or pins, as illustratively shown by the positioning pin 6 in FIG. 2 and the lifting bore 17 in FIG. 4. The positioning pin 6 affords assistance in the positioning and subsequent attachment of the slewing ring 10 to a component, and the lifting bore 17 can aid in the lifting, movement and positioning of the ring 10. In addition, the slewing ring 10 of the present invention can optionally include a lubricant fitting 77 for introducing grease or similar lubricants between the inner 12 and outer 14 races, as shown in FIG. 3.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

1. A slewing ring comprising:
an annular outer race and an annular inner race rotatably coupled thereto, said outer race and said inner race arranged concentrically about an axis;
a bearing, said bearing located between said outer race and said inner race;
said inner race having an annular upper member and an annular lower member, said upper member having a retaining segment extending coaxially with said axis and said lower member having a U-shaped recess adapted to accept said retaining segment, for the purpose of enhancing the dimensional stability of the slewing ring.

2. The invention of claim 1, wherein the depth of the U-shaped recess is between 0.05 and 35 percent of the overall axial height of said inner race.

3. The invention of claim 1, wherein the depth of the U-shaped recess is between 1 and 1 percent of the overall axial height of said inner race.

4. The invention of claim 1, wherein said outer race has a first radial bearing surface and said inner race has a second radial bearing surface oppositely disposed from said first bearing surface.

5. The invention of claim 4, further comprising a first radial bearing ring and a second radial bearing ring, said first bearing ring adjacent to said first bearing surface and said second ring bearing adjacent to said second bearing surface.

6. The invention of claim 5, wherein said bearing is located between and adjacent to said first bearing ring and said second bearing ring.

7. The invention of claim 1, wherein said outer race includes a first attachment means for attaching said outer race to a first component.

8. The invention of claim 1, wherein said inner race includes a second attachment means for attaching said inner race to a second component.

9. The invention of claim 1, wherein said annular upper member includes a lower member attachment means, said attachment means selected from the group consisting of an aperture, a threaded aperture, a pin, a rod, a bolt and combinations thereof.

10. The invention of claim 1, wherein said outer race includes a positioning pin, said pin extending axially from said outer race in a direction towards a first component.

11. The invention of claim 1, further comprising said annular lower member of said inner race including a lubricant fitting.

12. The invention of claim 1, further comprising said outer race including a first radial bearing surface and a second radial bearing surface and said inner race including a third radial bearing surface and a fourth radial bearing surface, wherein said first bearing surface is oppositely disposed from said third bearing surface and said second bearing surface is oppositely disposed from said fourth bearing surface.

13. The invention of claim 12, further comprising a first radial bearing ring adjacent to said first bearing surface, a second radial bearing ring adjacent to said second bearing surface, a third radial bearing ring adjacent to said third bearing surface, and a fourth radial bearing ring adjacent to said fourth bearing surface.

14. The invention of claim 13, further comprising a first roller bearing and a second roller bearing, wherein said first roller bearing is located between and adjacent to said first and third bearing rings and said second roller bearing is located between said second and fourth bearing rings.

15. The invention of claim 1, wherein said bearing is selected from the group consisting of a ball bearing, a roller bearing, a needle roller bearing, a tapered roller bearing and a spherical roller bearing.

16. A slewing ring for enhancing dimensional stability between two attached components comprising:
an annular outer race and an annular inner race rotatably coupled thereto, said outer race and said inner race arranged concentrically about a axis and having a bearing located therebetween;
said outer race having a first attachment means for attaching said outer race to a first component, a first radial bearing surface and a second radial bearing surface with a step region therebetween;
said inner race having an annular upper member and an annular lower member, said upper member having a second attachment means for attaching said inner race to a second component, a lower member attachment means, a third radial bearing surface, a retaining segment extending coaxially with said axis and a threaded surface for engaging said lower member;
said lower member having a fourth radial bearing surface, a threaded surface for engaging said upper member and a U-shaped recess adopted to accept said retaining segment of said upper member;
a first radial bearing ring adjacent said first bearing surface, a second radial bearing ring adjacent said second bearing surface, a third radial bearing ring adjacent said third bearing surface and a fourth radial bearing ring adjacent said fourth bearing surface;
a first bearing located between and adjacent to said first and said third bearing rings; and
a second bearing located between and adjacent to said second and said fourth bearing rings, for the purpose of enhancing the dimensional stability between two attached components.
